(19) United States
(12) Patent Application Publication
(10) Pub. No.: US 2014/0061252 A1
(43) Pub. Date: Mar. 6, 2014

(54) LIQUID DISPENSERS AND METHODS FOR MAKING THE SAME

(71) Applicants: Steven L. Sweeton, Lake Winnebago, MO (US); George R. Hildebrand, Independence, MO (US)

(72) Inventors: Steven L. Sweeton, Lake Winnebago, MO (US); George R. Hildebrand, Independence, MO (US)

(73) Assignee: Meadwestvaco Calmar, Inc., Richmond, VA (US)

(21) Appl. No.: 14/115,023

(22) PCT Filed: May 3, 2012
(86) PCT No.: PCT/US2012/036238

§ 371 Date: Oct. 31, 2013

Related U.S. Application Data
(60) Provisional application No. 61/481,871, filed on May 3, 2011.

(51) Int. Cl. G01F 11/00

(52) U.S. Cl. CPC B67D 7/60
USPC 222/321.8; 222/324

(57) ABSTRACT

Fluid dispensing devices having a pump system connected to a container wherein the dispensing device may be operated with one hand using either a container having a griping surface or opening or a handle integrated with an actuator to facilitate one-handed use.

### CROSS-REFERENCE TO RELATED APPLICATIONS

This application claims the benefit of, and priority to, U.S. Provisional Application No. 61/481,871, entitled “LIQUID DISPENSERS AND METHODS FOR MAKING THE SAME,” filed 3 May 2011, and incorporates the same herein by reference in its entirety.

### BACKGROUND OF THE INVENTION

1. Field of the Invention

Embodiments of the invention relate generally to liquid dispensers and dispensing systems capable of one-handed operation and more particularly to dispensers capable of dispensing liquid soaps or laundry products.

2. State of the Art

Liquid dispensers come in all shapes and sizes and are used for dispensing a variety of liquids. Dispensers and dispensing devices used in the laundry care markets are typically large bottles having a gravity fed valve or a pour spout. Such dispensing devices are often cumbersome and difficult to use due to the size of the bottle and forces required to either pour or dispense the product from the dispensing device. As a result, there is a demand for dispensing devices which offer alternatives to the current devices. There is also a demand for devices which allow a user to operate a dispenser with one hand.

### BRIEF SUMMARY OF THE INVENTION

According to certain embodiments of the invention, a dispensing device may include a pump system having a large, angled spout allowing the downward dispensing of a product into a wash basin or other delivery area. The dispensing device may also include a bottle or container handle having an angle on an interior of the bottle or container such that a dip tube used with the pump system may be forced into a particular portion or location within the bottle or container. The dispensing device may also include a wide, ergonomic actuator which may be actuated by the palm of a hand or a thumb as a user grips a bottle or container to which a pump system is attached and to which the actuator is in communication for actuating the pump system.

According to other embodiments of the invention, a dispensing device may include a pump system mounted on a bottle or other container such as a pouch. The pump system may include an integrated actuator and handle wherein a leaf-spring or other integrated spring facilitates movement of the actuator with respect to the handle. The integrated handle and actuator may include an integrated connector capable of attaching to a bottle or other container through mechanisms such as a screw closure or a bayonet type closure. In other embodiments, a connector may be paired with the integrated handle and actuator to connect it to a bottle or container.

### BRIEF DESCRIPTION OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1 illustrates a dispensing device according to various embodiments of the invention;

FIG. 2 illustrates a dispensing device according to various embodiments of the invention;

FIG. 3 illustrates a dispensing device according to various embodiments of the invention; and

FIG. 4 illustrates a dispensing device according to various embodiments of the invention.

### DETAILED DESCRIPTION OF THE INVENTION

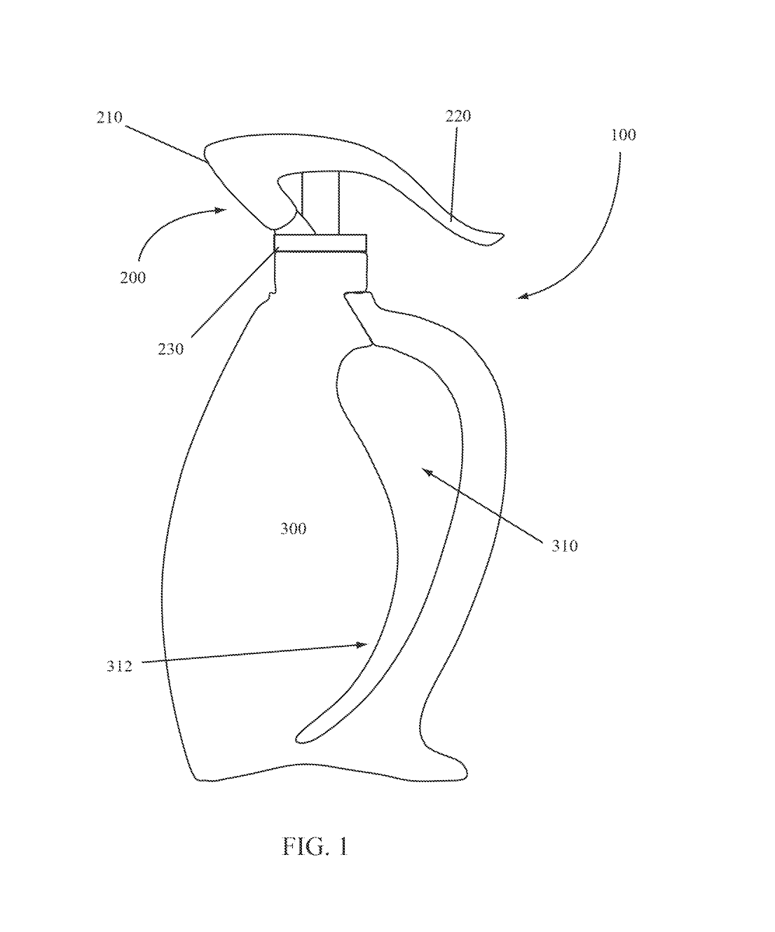

According to various embodiments of the invention, a dispensing device 100 may include a pump system 200 in communication with a container 300, such as the bottle illustrated in FIG. 1. While the container 300 illustrated in FIG. 1 is a bottle, it is understood that various embodiments of the invention may include other containers such as pouches or the like.

According to some embodiments of the invention, a pump system 200 may include a connector 230, an actuator 220 and a spout 210 in communication with a pump. For example, a dispensing device 100 according to embodiments of the invention is illustrated in FIG. 1. While a pump is not specifically illustrated, any conventional pump may be used with embodiments of the invention and the pump system 200 may be attached to or otherwise put in communication with a pump according to customary practice. For example, a pump having an accumulator, a piston, a dip tube, and an inlet and outlet may be mounted to or connected to the pump system 200 such that upon actuation of the actuator 220, product is pumped from an interior of the container 300 through the pump and out the spout 210 of the pump system 200.

As illustrated in FIG. 1, a container 300 may include an opening 310 or hole through the container 300 which may facilitate griping of the container 300 by a user. According to certain embodiments of the invention, a user may grip the container 300 illustrated in FIG. 1 through the opening 310 such that their thumb or finger may rest on a portion of the actuator 220. Application of a downward force on the actuator 220 may actuate the pump, allowing product to flow from an interior of the container 300, through the pump system 200, and out a spout 210. The positioning, design, and shape of the opening 310 in the container 300 in relation to the position of the actuator 220 of the pump system 200 may be tailored or customized such that a user may carry, use, and actuate the dispensing device 100 using one hand. In addition, the distance between the container 300 and the actuator 220 may be tailored or customized to improve the dispensing stroke and volume of product pumped.

For example, according to various embodiments of the invention, the distance between the container 300 and the actuator 220 may range from between about 0 cm to about 12.7 cm (5 inches). In other embodiments, the distance may vary between about 2.5 cm (1 inch) and about 12.7 cm (5 inches). In other embodiments of the invention, the distance between the container 300 and actuator 220 may be customized based on the output size of a pump used with the pump system 200 such that the output through one stroke of the actuator 220 is up to about 100 mL.

In some embodiments of the invention, the distance between a top surface of the actuator 220 and a user contact surface of a gripping handle 222 may be anywhere between about 0.3 cm (0.100 inches) and about 8.9 cm (3.500 inches). According to some embodiments of the invention, a pump incorporated with the pump system 200 may be configured to pump between about 5 mL to about 30 mL of fluid through the pump system 200 during a single actuation of the handle 222.

According to some embodiments of the invention, a container 300 may also include a sloped interior wall 312. The sloped interior wall 312 may be sloped in such a way that upon insertion of a dip tube used with a pump in a pump system 200, the dip tube may contact the sloped interior wall 312 and be directed to a location within the container 300 from which a product is to be collected. The positioning of the dip tube using a sloped interior wall 312 may assist with complete or maximized evacuation of a product from a container 300. For example, the container 300 illustrated in FIG. 1 includes a sloped interior wall 312 which will guide a dip tube towards a front portion of the container 300 or that portion in-line with the spout 210 as illustrated.

According to certain embodiments of the invention, a spout 210 may be angled in a downward direction as illustrated in FIG. 1. A downward angle of the spout 210 may facilitate the dispensing of a product from the pump system 200 towards a wash basin or other desired area.

A connector 230 according to embodiments of the invention may include any type of connecting device used to secure a pump or pump system 200 to a container 300. For example, a connector 230 may include a screw-type closure, a bayonet-type closure, a snap-fit closure, or other convention closure mechanism or system.

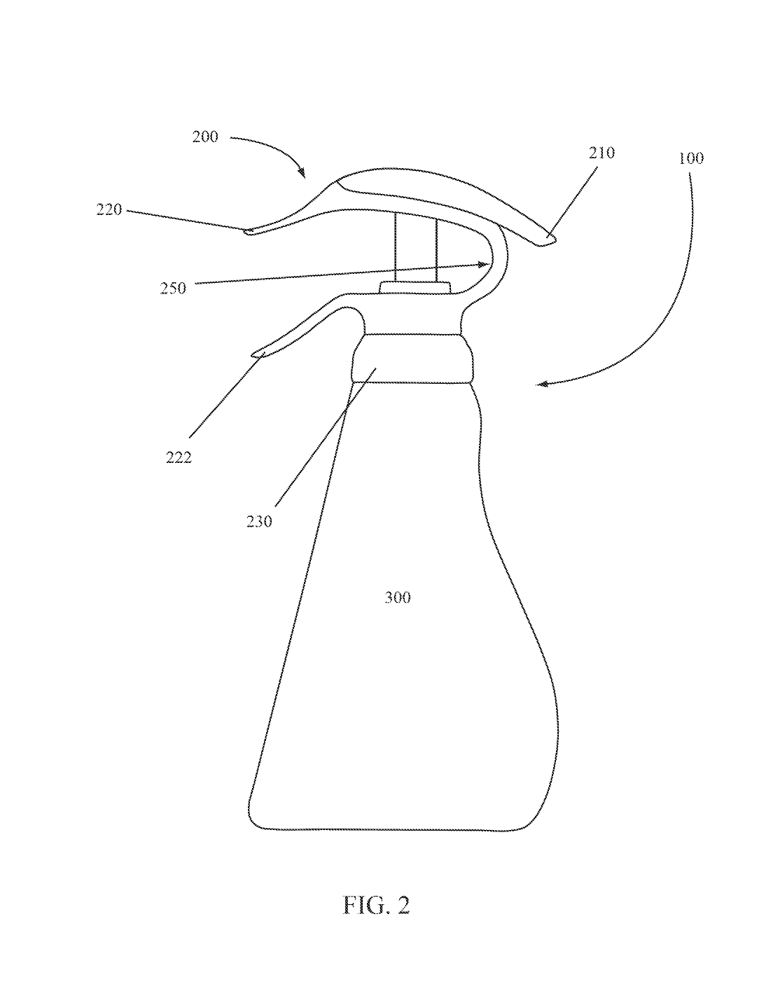

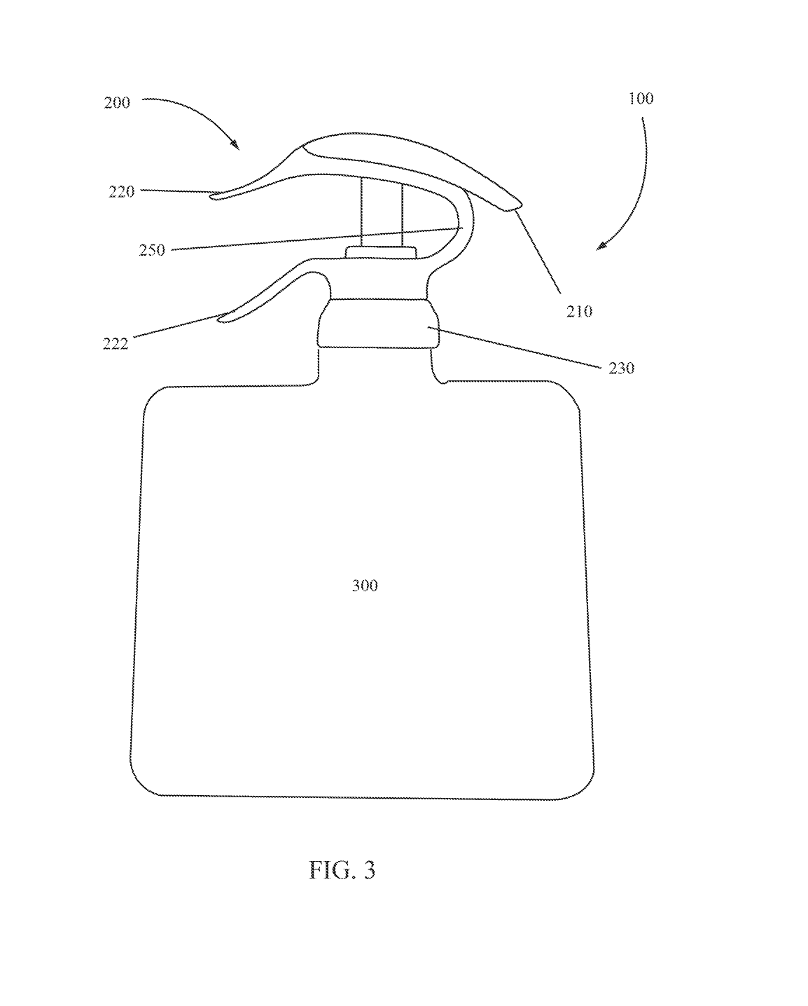

A dispensing device 100 according to other embodiments of the invention is illustrated in FIG. 2. A dispensing device 100 may include a container 300 connected to a pump system 200. The pump system 200 may include an actuator 220, a handle 222 and a spring 250. According to certain embodiments of the invention, the actuator 220 and handle 222 may be integrated with the spring 250 such that the handle 222, spring 250 and actuator 220 form a single component. A connector 230 may secure the pump system 200 to a container 300. A spout 210 may direct the output of product pumped through a pump attached to the pump system 200.

According to some embodiments of the invention, a spring 250 may include a leaf-spring. In certain embodiments, a spring 250 may include a circular or elliptical curve. In still other embodiments, a spring 250 may include multiple arms or segments such that the spring 250 need not be formed of a solid piece but may include openings or holes through at least a portion of the spring 250.

During operation, the handle 222 of the pump system 200 illustrated in FIG. 2 may be gripped by a user. The actuator 220 may then be actuated by the user's thumb. The spring 250 may flex with the application of force to the actuator 220 causing actuation of the actuator 220. Upon release of an actuation force, the spring 250 may return the actuator 220 to a non-actuated position. The configuration illustrated in FIG. 2 may allow a user to easily grip and actuate the dispensing device 100 using one hand.

According to various embodiments of the invention, an integrated handle 222, spring 250 and actuator 220 may be made of polyolefin. In other embodiments of the invention, the integrated handle 222, spring 250, and actuator 220 may be made of polypropylene. In still other embodiments of the invention, other plastics or resins may be used to form or mold components of the pump system 200.

According to various embodiments of the invention, a distance between the handle 222 and actuator 220 may be customized or tailored to an intended application. In some embodiments, the distance between an outer point of the actuator 220 and outer point of the handle 222 may be between 0 inches and about 5 inches. In other embodiments it may be between about 1 inch and about 5 inches.

In some embodiments of the invention, the output of the pump system 200 may also be tailored or customized to provide a desired output relative to the actuation stroke length between the handle 222 and actuator 220. For example, in certain applications, it may be desirable to customize a pump capacity and stroke length to provide an output of up to 100 mL or more of product.

A dispensing device 100 according to still other embodiments of the invention is illustrated in FIG. 3. As illustrated, a pump system 200 similar to that illustrated in FIG. 2 may be attached to or connected to a container 300, wherein the container is a flexible pouch.

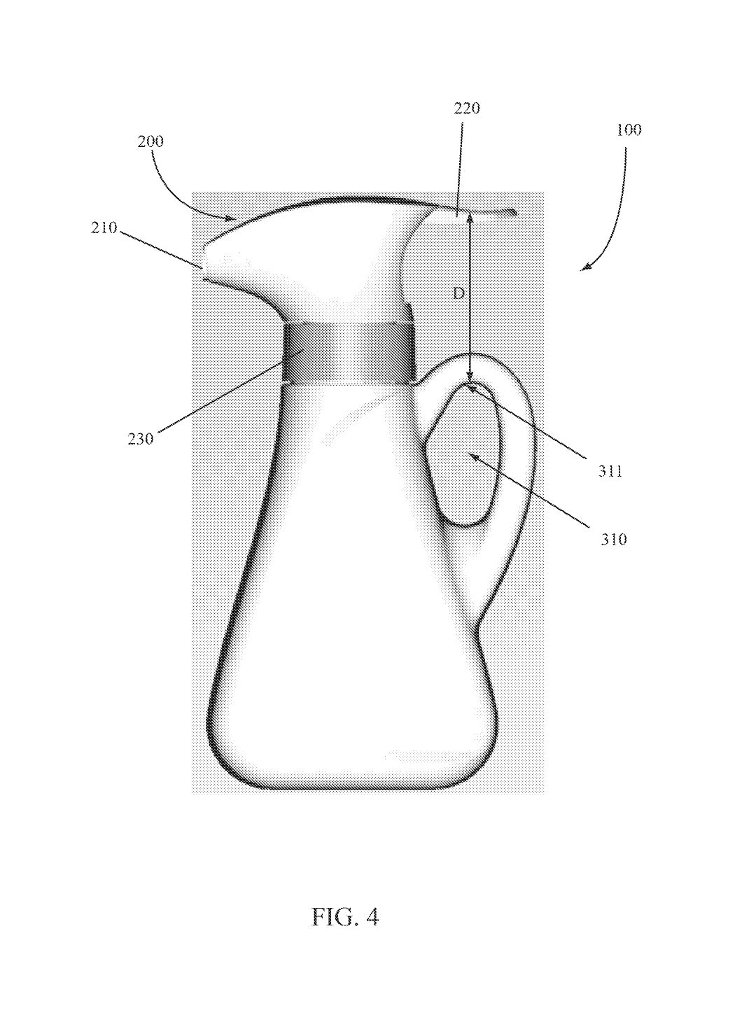

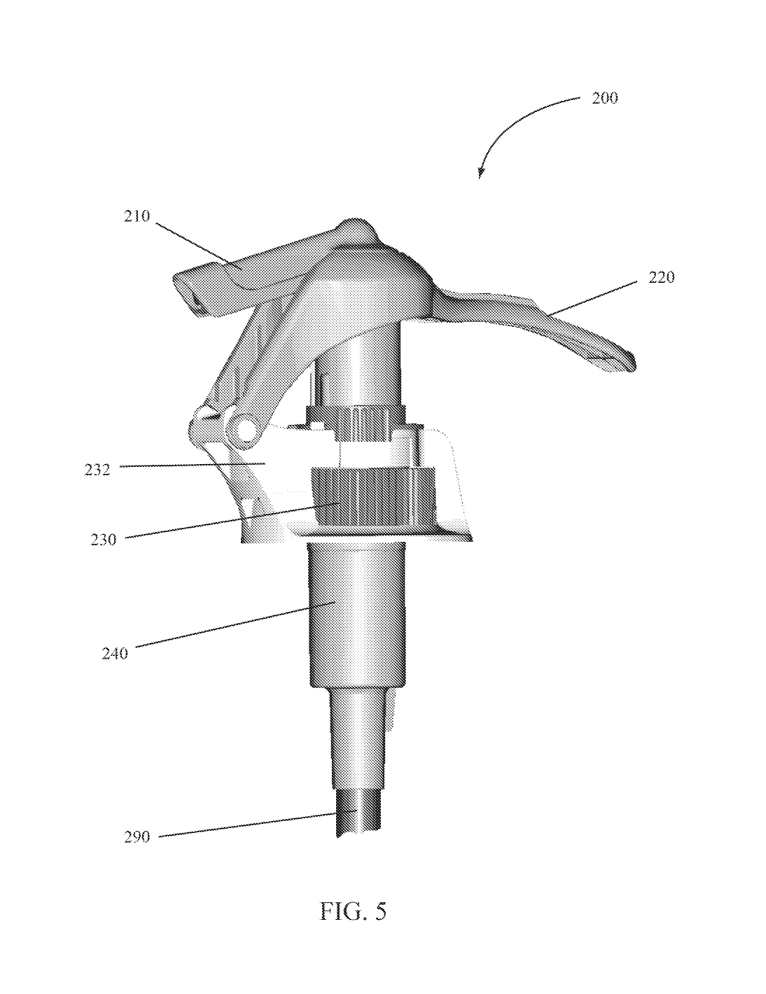

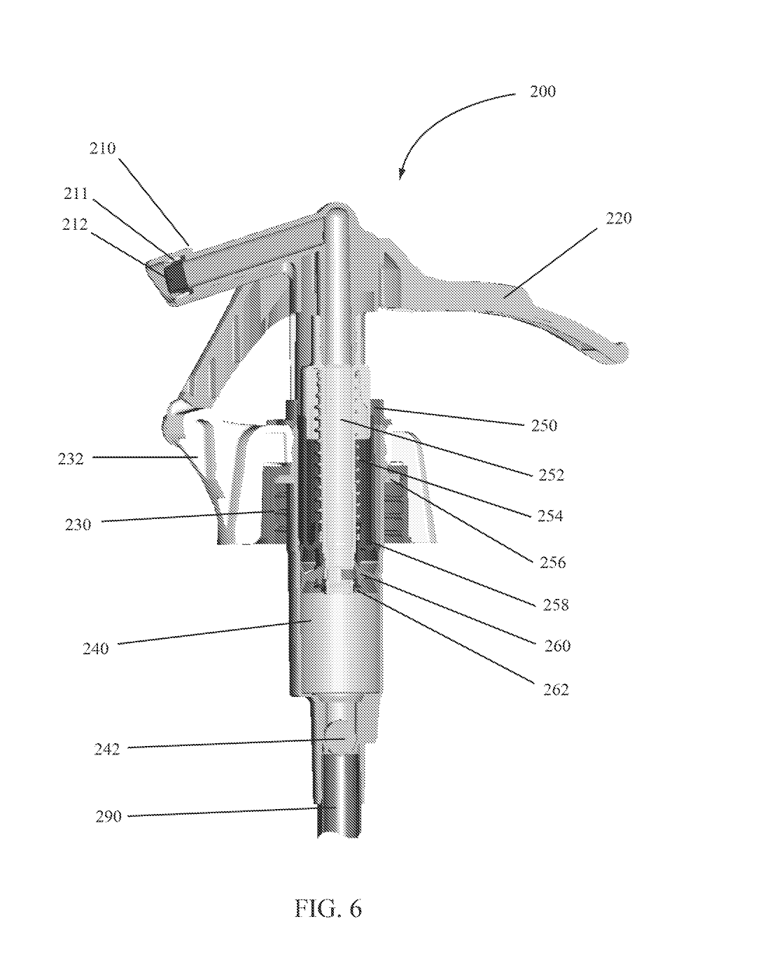

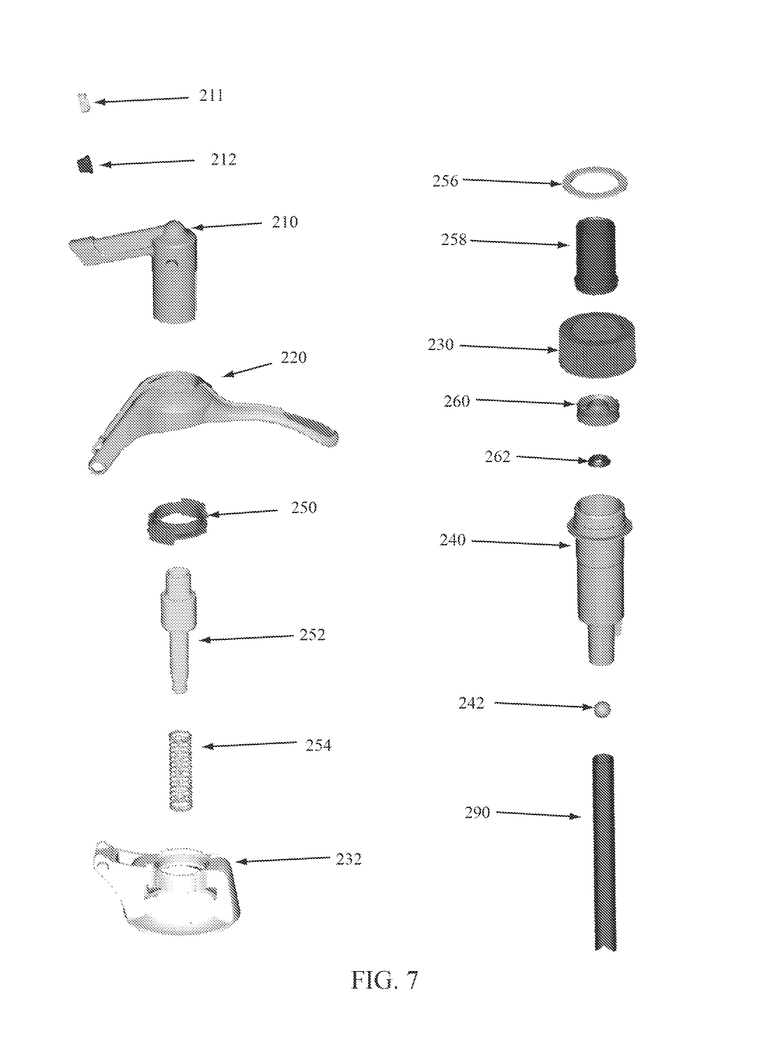

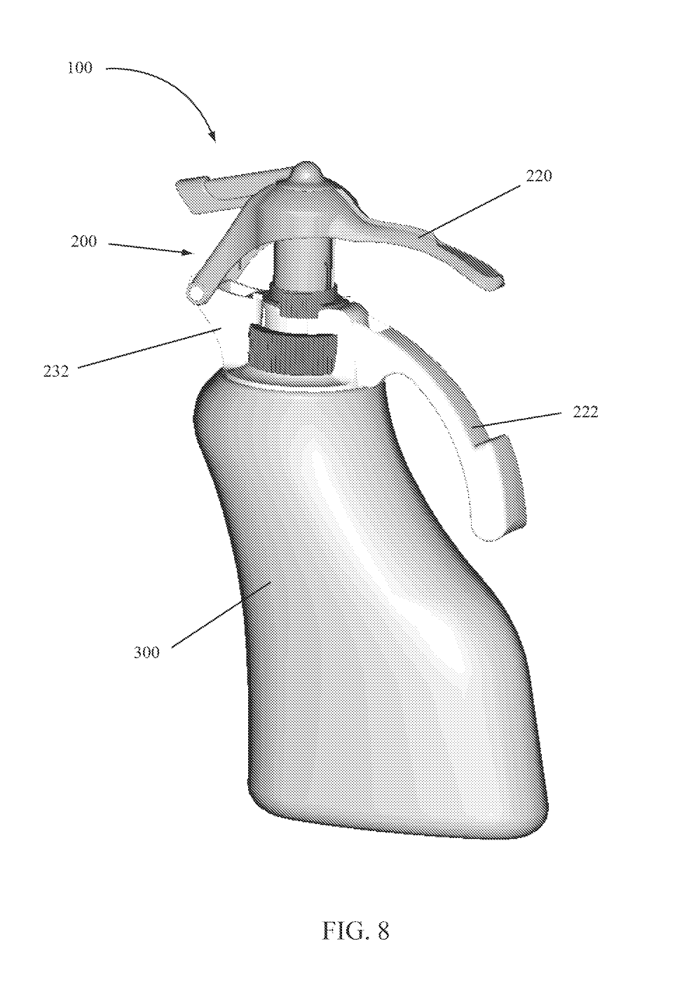

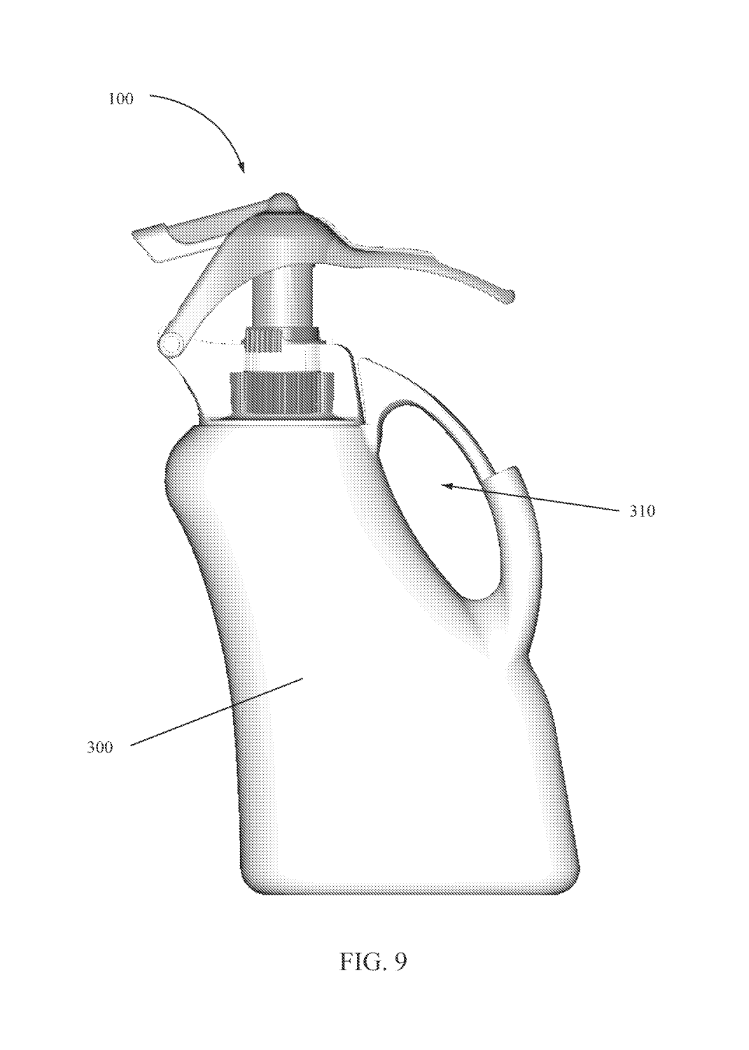

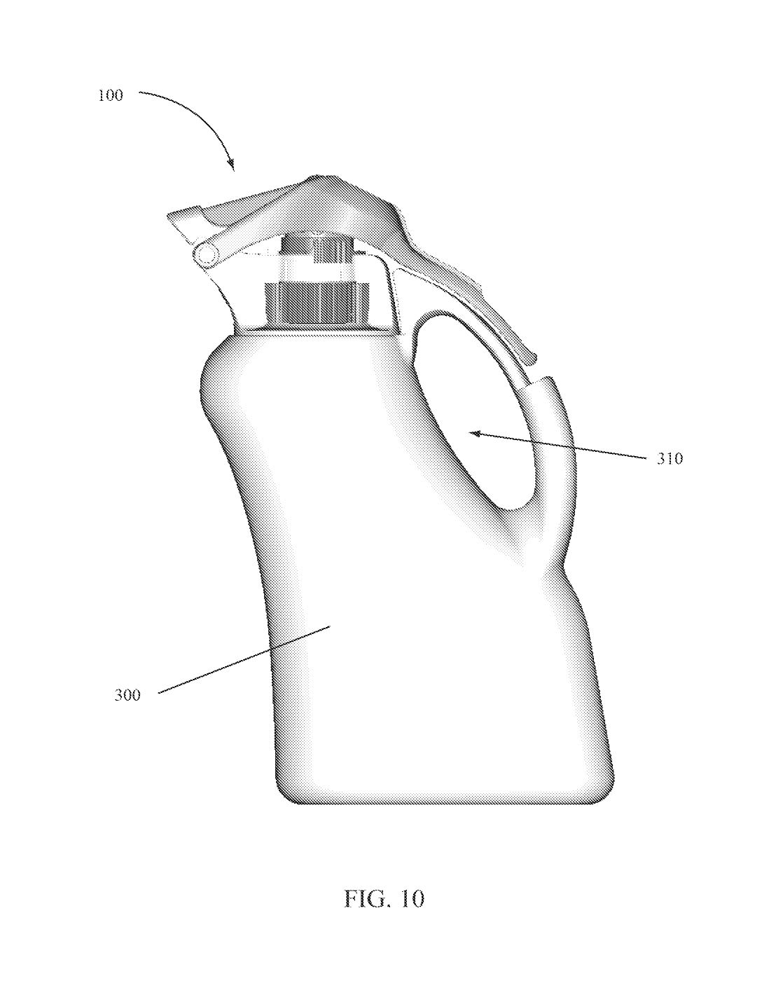

A dispensing device 100 according to still other embodiments of the invention is illustrated in FIG. 4. The dispensing device 100 may include a pump system 200 attached to a container 300. The container 300 may include an opening 310 having an upper surface 311 wherein a finger or other portion of a user's hand may rest during transport and operation. The pump system 200 may include an actuator 220 upon which a user's finger or thumb may rest during operation or pumping of the pump system 200. For instance, a user may hold the dispensing device 100 with a portion of their hand through the opening 310 and their thumb resting on a top surface of the actuator 220. In operation, a user may apply force to the actuator and to the container to pump the pump system 200. In various embodiments of the invention, a distance “D” may exist between the upper surface 311 of the container 300 and the top surface of the actuator 220 as illustrated in FIG. 4. The distance “D” may be anywhere between about 0.3 cm (0.100 inches) and about 8.9 cm (3.500 inches) and a pump incorporated with the pump system 200 may be configured to pump between about 5 mL to about 30 mL of fluid through the pump system 200 during actuation of the actuator 220.

Various pump systems 200 according to some embodiments of the invention are illustrated in FIGS. 5 through 10. For example, a pump system 200 according to some embodiments of the invention is illustrated in FIGS. 5 and 6. As shown in the exterior perspective view of FIG. 5, an assembled pump system 200 may include a spout 210, an actuator 220, a connector 230, a stanchion 232, an accumulator 240, and a dip tube 290. A cross-sectional view of the pump system 200 illustrated in FIG. 5 is illustrated in FIG. 6.

Components of a pump system 200 according to various embodiments of the invention may include those components illustrated in the blown-apart view of a pump system 200 of FIG. 7. As illustrated, a pump system 200 may include a spout 210, an accumulator 220, an optional locking ring 250, a piston stem 252, a spring 254, a stanchion 232, a gasket 256, a spring cylinder 258, a connector 230, a piston seal 260, a plug seal 262, an accumulator 240, a ball or valve 242, and a dip tube 290. In some embodiments, a discharge valve 212 and a discharge valve retainer 211 may also be included.

According to various embodiments of the invention, the components of a pump system 200 may be assembled as illustrated in FIG. 6. The components may also be assembled in conventional ways to form a functioning pump system 200. While various components are illustrated as being part of a pump system 200 according to embodiments of the invention, it is understood that other components may be substituted for those illustrated or combined to create a pump system 200 having fewer parts. For example, a plastic valve system may be substituted for the ball 242 valve illustrated. Also, a spring may include a metal, plastic, or other material spring or may be integrated with the actuator 220 as illustrated in other embodiments of the invention. As a further example, the illustrated connector 230 is of a screw-type connector but other types of connectors could be used such as a bayonet connector; also, the connector could be integrated into the stanchion 232 if desired to reduce the part count of the pump system 200.

An alternative dispensing device 100 according to embodiments of the invention is illustrated in FIG. 8. As illustrated, the dispensing device 100 may include a pump system 200 attached to a container 300. The pump system 200 may include a stanchion 232 having a gripping handle 222 integrated therewith. The gripping handle 222 in combination with the actuator 220 may allow a user to carry and actuate the pump system 200 as desired.

FIGS. 9 and 10 illustrate an embodiment of the present invention in a non-actuated state and an actuated state, respectively. As illustrated in FIG. 9, a pump system 200 may be mounted to a container 300 having an opening 310 therein. A user may grasp the opening 310 of the container 300 and rest a thumb on the actuator 220. Upon a user's application of force to the actuator 220, the opening 310 in the container 300, or both, the pump system 200 may be actuated such that the actuator 220 is brought towards the container 300 as illustrated in FIG. 10. The spout 210 may also move during actuation as illustrated in FIGS. 9 and 10.

Dispensing devices 100 according to various embodiments of the invention may be used with liquid products. In some embodiments, a dispensing device 100 may be customized to be used with a laundry product such as laundry detergent. The pump system 200 may be configured to dispense a particular dosage of liquid as desired and the spout 210 configuration and actuator 220 configuration may be customized for the user or for the application for which the dispensing device 100 is to be used.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

What is claimed is:

1. A dispensing device, comprising:
a container, comprising an opening through the container; a pump system attached to the container, the pump system comprising:
an actuator;
a spout; and
a connector;
wherein a distance between the upper surface of the container opening and a top surface of the actuator is between about 0.3 cm and about 8.9 cm.

2. The dispensing device of claim 1, wherein the distance is about 8.9 cm.

3. The dispensing device of claim 1, wherein a user may grip the opening and actuator with one hand.

4. The dispensing device of claim 1, wherein the container further comprises a container selected from the group consisting of a bottle and a pouch.

5. A dispensing device, comprising:
a container;
an integrated handle, spring, and actuator;
a pump supported by the integrated handle, spring, and actuator;
a connector connecting the integrated handle, spring, and actuator to the container; and
a spout in communication with the pump.

6. The dispensing device of claim 5, wherein the integrated handle, spring, and actuator comprises an integrated handle, spring, and actuator formed of a molded polyolefin material.

7. The dispensing device of claim 5, wherein the integrated handle, spring, and actuator comprises an integrated handle, spring, and actuator formed of a molded polypropylene material.

8. The dispensing device of claim 5, wherein the integrated handle, spring, and actuator further comprises an integrated handle, leaf spring, and actuator.

9. The dispensing device of claim 5, wherein the container comprises a container selected from the group consisting of a bottle and a pouch.

10. The dispensing device of claim 5, wherein a distance between a top surface of the actuator and a bottom surface of the handle is between about 0.3 cm and about 8.9 cm.

11. The dispensing device of claim 10, wherein actuation of the dispensing device dispenses between about 5 mL and about 30 mL of a product from the container.

12. A pump system, comprising:
a handle;
an actuator; and
a spring between the handle and actuator, wherein the handle, actuator, and spring are formed as an integral component.

13. The pump system of claim 12, further comprising a connector and a container, wherein the connector connects the handle, actuator, and spring to the container.

14. The pump system of claim 13, wherein the connector is selected from the group consisting of a screw-type connector and a bayonet-type connector.

15. The pump system of claim 12, wherein the handle, actuator, and spring comprise polyolefin.

16. The pump system of claim 12, wherein the handle, actuator, and spring comprise polypropylene.

17. The pump system of claim 12, further comprising a distance between the handle and actuator, wherein the distance is less than about 5 inches.
